(19) United States
(12) Patent Application Publication
(10) Pub. No.: US 2023/0382380 A1
(43) Pub. Date: Nov. 30, 2023

(54) SYSTEMS AND METHODS FOR VEHICULAR CONTROL WHILE FOLLOWING A VEHICLE

(71) Applicant: Honda Motor Co., Ltd., Tokyo (JP)

(72) Inventor: Jose I. Herrero Zarzosa, Powell, OH (US)

(21) Appl. No.: 17/751,786

(22) Filed: May 24, 2022

(51) Int. Cl. B60W 30/165; B60W 30/12; G06V 20/56; G06V 20/58

(52) U.S. Cl. CPC B60W 30/165; B60W 30/12; G06V 20/588; G06V 20/584; B60W 2420/42; B60W 2552/53; B60W 2710/20; B60W 2554/802; B60W 2554/4041; B60W 2554/402; B60W 2556/40; B60W 2556/45; B60W 2554/4045; B60W 2552/10; G06V 2201/08

(57) ABSTRACT

A vehicle is provided. The vehicle includes a plurality of sensors including a first sensor. The vehicle also includes a vehicle controller. The vehicle controller is programmed to (i) collect a plurality of sensor information; (ii) detect a first vehicle ahead of the vehicle in a direction of travel of the vehicle; (iii) detect two or more taillights of the first vehicle based on the plurality of sensor information; (iv) determine a distance between the two or more taillights; (v) calculate a following distance between the first vehicle and the vehicle based on the distance between the two or more taillights and the plurality of sensor information; (vi) detect a plurality of lane markings based on the plurality of sensor information; and (vii) adjust steering of the vehicle to follow the first vehicle based on the plurality of lane markings and the following distance.

### FIELD OF THE INVENTION

The present disclosure relates to vehicular control and navigation and, more particularly, to a system and method for controlling a vehicle following another vehicle.

### BACKGROUND

Following a vehicle can be difficult for autonomous and semi-autonomous vehicles. Some adaptive cruise controller (ACC) and lane keeping assistance system (LKAS) technologies have issues. These issues include that proper detection works well during good weather conditions, but can have difficulties at night or during uneven weather conditions, such as rain. Many times the disengagement of the LKAS can happen quickly. And some steering systems are limited to only applying 0.8 G of force. If this force is applied late, then the vehicle may not be able to follow the lane, such as in a continuous curve. As autonomous and semi-autonomous cars become more widespread, it would be desirable to have a system that assists drivers and/or vehicles in following other vehicles through traffic situations.

### BRIEF SUMMARY

In one aspect, a vehicle is provided. The vehicle includes a plurality of sensors including a first sensor. The vehicle also includes a vehicle controller. The vehicle controller is programmed to collect a plurality of sensor information observed by at least the first sensor during operation of the vehicle. The vehicle controller is also programmed to detect a first vehicle ahead of the vehicle in a direction of travel of the vehicle based on the plurality of sensor information. The vehicle controller is further programmed to detect two or more taillights of the first vehicle based on the plurality of sensor information. In addition, the vehicle controller is programmed to determine a distance between the two or more taillights. Moreover, the vehicle controller is programmed to calculate a following distance between the first vehicle and the vehicle based on the distance between the two or more taillights and the plurality of sensor information. Furthermore, the vehicle controller is programmed to detect a plurality of lane markings based on the plurality of sensor information. In addition, the vehicle controller is also programmed to adjust steering of the vehicle to follow the first vehicle based on the plurality of lane markings and the following distance. The vehicle may have additional, less, or alternate functionality, including that discussed elsewhere herein.

In another aspect, a computer device is provided. The computer device includes at least one memory and at least one processor in communication with the at least one memory. The at least one processor is programmed to collect a plurality of sensor information observed by at least the first sensor during operation of the vehicle. The at least one processor is also programmed to detect a first vehicle ahead of the vehicle in a direction of travel of the vehicle based on the plurality of sensor information. The at least one processor is further programmed to detect two or more taillights of the first vehicle based on the plurality of sensor information. In addition, the at least one processor is programmed to determine a distance between the two or more taillights. Moreover, the at least one processor is programmed to calculate a following distance between the first vehicle and the vehicle based on the distance between the two or more taillights and the plurality of sensor information. Furthermore, the at least one processor is programmed to detect a plurality of lane markings based on the plurality of sensor information. In addition, the at least one processor is also programmed to adjust steering of the vehicle to follow the first vehicle based on the plurality of lane markings and the following distance. The computer device may have additional, less, or alternate functionality, including that discussed elsewhere herein.

In still another aspect, a method for controlling a vehicle is provided. The method is implemented on a vehicle controller associated with the vehicle including at least one processor in communication with at least one memory. The method includes collecting a plurality of sensor information observed by at least a first sensor during operation of the vehicle. The method also includes detecting a first vehicle ahead of the vehicle in a direction of travel of the vehicle based on the plurality of sensor information. The method further includes detecting two or more taillights of the first vehicle based on the plurality of sensor information. In addition, the method includes determining a distance between the two or more taillights. Moreover, the method includes calculating a following distance between the first vehicle and the vehicle based on the distance between the two or more taillights and the plurality of sensor information. Furthermore, the method includes detecting a plurality of lane markings based on the plurality of sensor information. In addition, the method also includes adjusting steering of the vehicle to follow the first vehicle based on the plurality of lane markings and the following distance. The method may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary vehicle, in accordance with one embodiment of the present disclosure.

FIG. 2 illustrates a schematic diagram of an exemplary first vehicle following a second vehicle, in accordance with one embodiment of the present disclosure.

FIG. 3 illustrates a schematic diagram of an exemplary system for following a vehicle, in accordance with at least one embodiment.

FIG. 4 illustrates a flowchart of a process for following a vehicle using the system shown in FIG. 3, in accordance with at least one embodiment.

FIG. 5 illustrates an exemplary configuration of a user computer device, in accordance with one embodiment of the present disclosure.

FIG. 6 illustrates an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

A computer program of one embodiment is embodied on a computer-readable medium. In an example, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

The present embodiments may relate to, inter alia, systems and methods for controlling a vehicle following another vehicle based upon sensor data. In an exemplary embodiment, the process is performed by a vehicle controller computer device, also known as a vehicle controller. In other embodiments, the vehicle controller computer device is a collection of controllers that communicate with each other to operate the following vehicle.

In the exemplary embodiment, the vehicle includes a plurality of sensors that allow the vehicle to observe its surroundings in real-time. The sensors can include, but are not limited to, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. The vehicle controller receives information from the sensors. In one embodiment, based on the information from the sensors, the vehicle controller detects and follows a vehicle. The vehicle controller analyzes the images of the first vehicle to determine the location and distance of the first vehicle and adjusts the operation of the following vehicle to safely follow the first vehicle. In a further embodiment, the vehicle controller determines that the first vehicle is changing lanes, and the vehicle controller changes lanes as well, if it is safe to do so. In another embodiment, the vehicle controller determines that the first vehicle is planning to make a turn (left or right). The vehicle controller uses the information from the sensors to safely follow the first vehicle through the turn. The vehicle controller controls the operation of the following vehicle based on a plurality of user preferences and safety considerations.

In the following vehicle embodiments, the vehicle controller of the following vehicle detects the first vehicle based on one or more images taken by one or more camera sensors of the following vehicle. The vehicle controller determines the boundaries of the first vehicle from the one or more images. Then the vehicle controller detects the rear lights of the first vehicle from the one or more images. Additionally, the vehicle controller determines the distance between the rear lights of the first vehicle from the one or more images. In some embodiments, the vehicle controller stores a plurality of categories and/or types of vehicles. This information can include information for how to recognize each category (trailer) or type (specific model) of vehicle. This information can also include the distance between the rear lights for each category or type of vehicle.

Then vehicle controller is then able to determine the distance between the first vehicle and the following vehicle based on the distance between the rear lights. The vehicle controller is also able to detect the lane markings based on the one or more images and determine where the first vehicle is in relation to those lane markings. The vehicle controller then can calculate a smoothed trajectory for the travel of the following vehicle. The vehicle controller then instructs the steering of the following vehicle to continue to follow the first vehicle.

In some further embodiments, the vehicle controller may determine that the first vehicle is changing lanes. In these embodiments, the vehicle controller determines which lane that the first vehicle is travelling into. Then the vehicle controller determines if it is safe for the following vehicle to change lanes as well. In some embodiments, the vehicle controller analyzes the data from one or more lateral sensors to determine if any vehicles are in the desired lane and how far away those vehicles are. If the vehicle controller determines that it is safe to do so. The vehicle controller instructs the steering to steer the vehicle into the desired lane. If it is not safe to go into the desired lane, the vehicle controller stops following the first vehicle.

In additional embodiments, the vehicle controller may determine that the first vehicle is making a turn. In these embodiments, the vehicle monitors the turn of the first vehicle and guides the following vehicle through the same turn if it is determined safe to do so. The vehicle controller may disengage from following the first vehicle if the following vehicle is unable to make the turn safely.

In some embodiments, the vehicle controller communicates with the adaptive cruise controller (ACC) to confirm the following distance between the following vehicle and the first vehicle. In some of these embodiments, the ACC may determine the following distance using one or more radar based sensors. The vehicle controller may also communicate with the lane keeping assistance system (LKAS) to determine and/or confirm where the lane markings are.

In some additional embodiments, the vehicle controller receives map and GPS information. In these embodiments, the vehicle controller knows the route that the following vehicle or the first vehicle is planning to take and can plan for lane changes, turns, changes in speed, and other actions during the route.

In further embodiments, the vehicle controller of the following vehicle may be in communication with first vehicle, such as through a vehicle-to-vehicle (V2V) wireless communication. The first vehicle can transmit information, such as lane change plans, turns, route directions, braking, current speed, and other information to assist the vehicle controller in determining how to safely follow the first vehicle.

At least one of the technical problems addressed by this system may include: (i) improving the safety of vehicular travel in a following situation; (ii) reducing the risks of travel for vehicles following another vehicle; (iii) improved accuracy in the prediction of actions of another vehicle along a roadway; and (iv) alerting the driver and/or vehicle to changes in the behavior of a followed vehicle.

The methods and systems described herein may be implemented using computer programming or engineering techniques including computer software, firmware, hardware, or any combination or subset thereof, wherein the technical effects may be achieved by performing at least one of the following steps: a) collect a plurality of sensor information observed by at least the first sensor during operation of the vehicle; b) detect a first vehicle ahead of the vehicle in a direction of travel of the vehicle based on the plurality of sensor information, wherein the first sensor is a front facing camera, and wherein the plurality of sensor information includes one or more images of the first vehicle captured by the front facing camera; c) detect two or more taillights of the first vehicle based on the plurality of sensor information; d) determine a distance between the two or more taillights; e) calculate a following distance between the first vehicle and the vehicle based on the distance between the two or more taillights and the plurality of sensor information; f) detect a plurality of lane markings based on the plurality of sensor information; g) adjust steering of the vehicle to follow the first vehicle based on the plurality of lane markings and the following distance; h) determine an outline of the first vehicle based on the plurality of sensor information; i) look-up at least one of a category and a type for the first vehicle based on the outline; j) retrieve the distance between the two or more taillights based on the look-up; k) confirm the following distance with an adaptive cruise controller (ACC); l) confirm the plurality of lane markings with a lane keeping assistance system (LKAS); m) retrieve map and/or Global Positioning System (GPS) information; n) receive travel information from the first vehicle via a wireless connection; o) engage in a vehicle following mode, wherein the vehicle controller is controlling the vehicle to follow the first vehicle; p) determine that the first vehicle is changing lanes based on the plurality of lane markings and the plurality of sensor information; q) determine whether or not it is safe for the vehicle to change lanes; r) if the determination is that it is safe for the vehicle to change lanes, follow the first vehicle in changing lanes; s) if the determination is that it is not safe for the vehicle to change lanes, disengage from following the first vehicle; t) determine that the first vehicle is making a turn based on the plurality of lane markings and the plurality of sensor information; u) determine whether or not it is safe for the vehicle to make the turn; v) if the determination is that it is safe for the vehicle to make the turn, follow the first vehicle in making the turn; w) transmit one or more instructions to a steering actuator of the vehicle to adjust the steering of the vehicle.

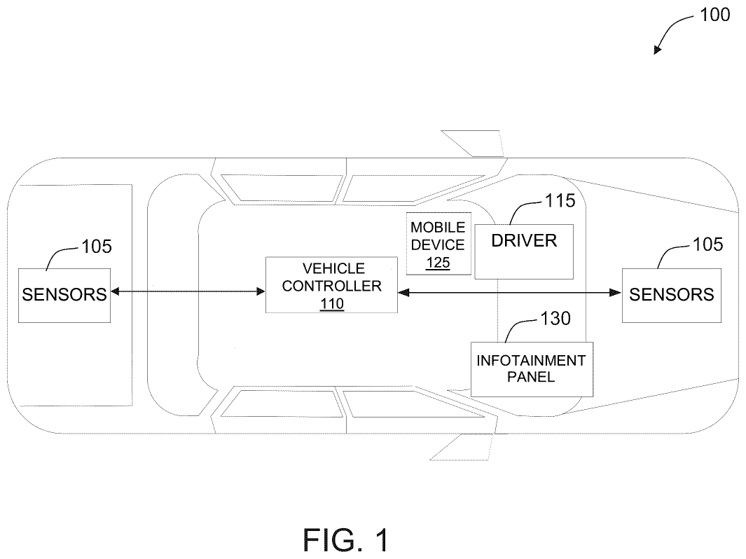

FIG. 1 depicts a view of an exemplary vehicle 100. In some embodiments, vehicle 100 may be an autonomous or semi-autonomous vehicle capable of fulfilling the transportation capabilities of a traditional automobile or other vehicle. In these embodiments, vehicle 100 may be capable of sensing its environment and navigating without human input. In other embodiments, vehicle 100 is a manual vehicle or a semi-autonomous vehicle with driver assistance systems, such as, but not limited to, lane keep assistance, adaptive cruise control, and parallel parking assistance, where the vehicle may be as a traditional automobile that is controlled by a driver 115.

Vehicle 100 may include a plurality of sensors 105 and a vehicle controller 110. The plurality of sensors 105 may detect the current surroundings and location of vehicle 100. Plurality of sensors 105 may include, but are not limited to, odometer, speedometer, accelerometers, wheel sensors, radar, LIDAR, proximity sensors, ultrasonic sensors, electromagnetic sensors, wide RADAR, long distance RADAR, Global Positioning System (GPS), video devices, imaging devices, cameras, audio recorders, and computer vision. Plurality of sensors 105 may also include sensors that detect conditions of vehicle 100, such as covered distance, speed, acceleration, gear, braking, and other conditions related to the operation of vehicle 100, for example: at least one of a measurement of at least one of speed, direction rate of acceleration, rate of deceleration, location, position, orientation, and rotation of the vehicle, and a measurement of one or more changes to at least one of speed, direction rate of acceleration, rate of deceleration, location, position, orientation, and rotation of the vehicle. Furthermore, plurality of sensors 105 may include impact sensors that detect impacts to vehicle 100, including force and direction and sensors that detect actions of vehicle 100, such the deployment of airbags. In some embodiments, plurality of sensors 105 may detect the presence of driver 115 and one or more passengers (not shown) in vehicle 100. In these embodiments, plurality of sensors 105 may detect the presence of fastened seatbelts, the weight in each seat in vehicle 100, heat signatures, or any other method of detecting information about driver 115 and/or passengers in vehicle 100.

In some embodiments, the plurality of sensors 105 may include sensors for determining weight distribution information of vehicle 100. Weight distribution information may include, but is not limited to, the weight and location of remaining gas, luggage, occupants, and/or other components of vehicle 100. In some embodiments, plurality of sensors 105 may include sensors for determining remaining gas, luggage weight, occupant body weight, and/or other weight distribution information. Furthermore, the plurality of sensors 105 may detect attachments to the vehicle 100, such as cargo carriers or bicycle racks attached to the top of the vehicle 100 and/or a trailer attached to a hitch on the rear of the vehicle 100.

In some embodiments, the plurality of sensors 105 include cameras, LIDAR, radar, proximity detectors, and/or other sensors 105 that provide information about the surroundings of the vehicle 100, such as, but not limited to, other vehicles including vehicle type and vehicle load, obstacles, traffic flow information including road signs, traffic lights, and other traffic information, and/or other environmental information.

Vehicle controller 110 may interpret the sensory information to identify appropriate navigation paths, detect threats, and react to conditions. In some embodiments, vehicle controller 110 may be able to communicate with one or more remote computer devices, such as mobile device 125. In the example embodiment, mobile device 125 is associated with driver 115 and includes one or more internal sensors, such as an accelerometer, a gyroscope, and/or a compass. Mobile device 125 may be capable of communicating with vehicle controller 110 wirelessly. In addition, vehicle controller 110 and mobile device may be configured to communicate with computer devices located remotely from vehicle 100.

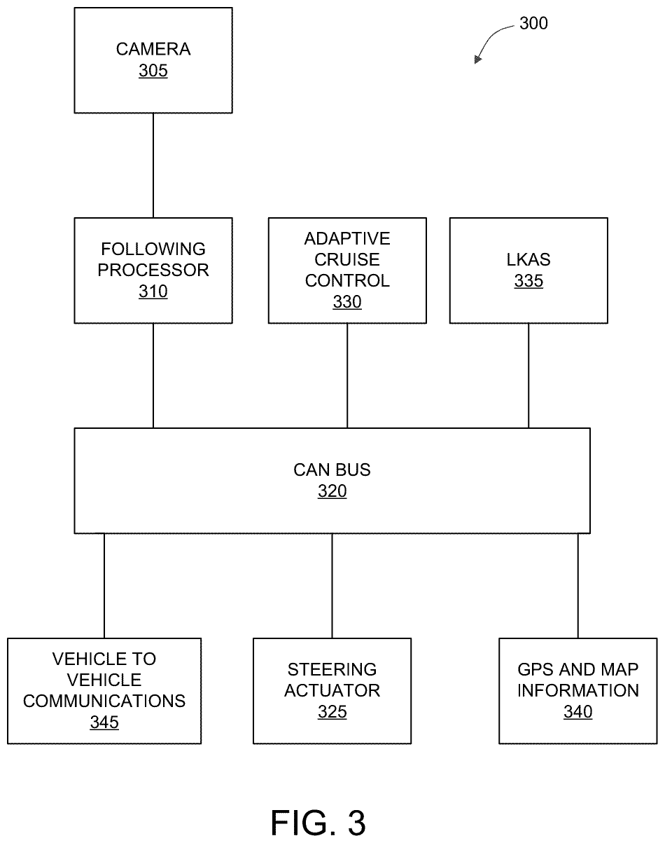

In some embodiments, the vehicle controller 110 is a plurality of controllers associated with different sensors and/or controls of the vehicle 100. The plurality of controllers are in communication with each other, such as through the CAN bus 320 (shown in FIG. 3).

The vehicle controller 110 may receive user preferences from the user through the mobile device 125 or an infotainment panel 130. The vehicle controller 110 may also receive preferences via one or more remote servers. These remote servers may be associated with the vehicle manufacturer or other service provider that provides preference information. The remote servers may also provide traffic information including, but not limited to, travel routes, maps, traffic light timing, and current traffic load in areas around the vehicle 100.

In some embodiments, vehicle 100 may include autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality. In these embodiments, the autonomous or semi-autonomous vehicle-related functionality or technology may be controlled, operated, and/or in communication with vehicle controller 110.

The wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; hazard avoidance; navigation or GPS-related systems; security and/or anti-hacking measures; and/or theft prevention systems.

While vehicle 100 may be an automobile in the exemplary embodiment, in other embodiments, vehicle 100 may be, but is not limited to, other types of ground craft, aircraft, watercraft, and spacecraft vehicles.

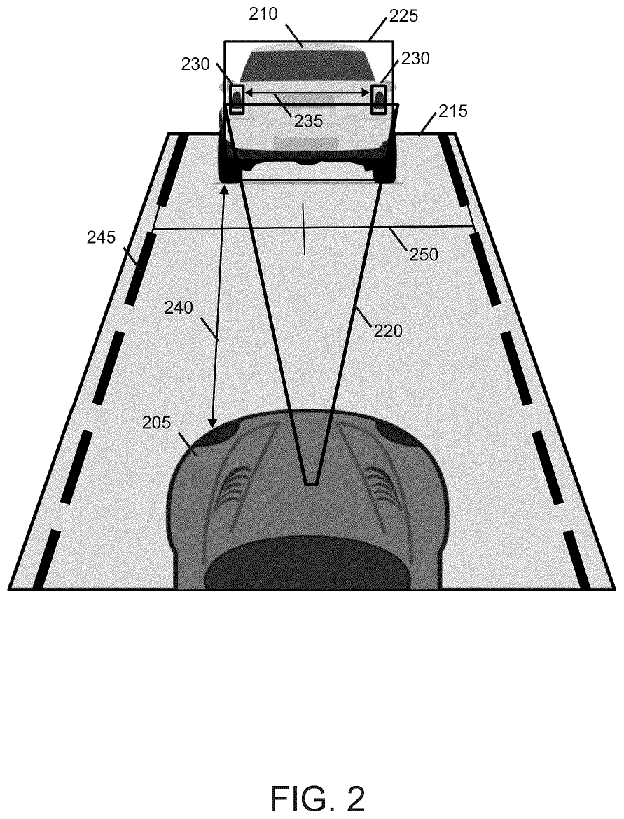

FIG. 2 illustrates a schematic diagram of an exemplary following vehicle 205 following a first vehicle 210, in accordance with one embodiment of the present disclosure. In the exemplary embodiment, following vehicle 205 is similar to vehicle 100 (shown in FIG. 1), where following vehicle 205 includes a vehicle controller 110 (shown in FIG. 1).

In the exemplary embodiment, the following vehicle 205 is following the first vehicle 210 on a roadway. The following vehicle 205 and the first vehicle 210 are in the same lane 215 while traveling on the roadway. In some embodiments, the driver 115 (shown in FIG. 1) has instructed the following vehicle 205 to follow the first vehicle 210. In other embodiment, the vehicle controller 110 of the following vehicle 205 has decided to follow the first vehicle 210.

The vehicle controller 110 of the following vehicle 205 receives sensor information 220 from one or more sensors 105 about the first vehicle 210 and the lane 215 that the following vehicle 205 and/or the first vehicle 210 are in. In the exemplary embodiment, the sensor information 220 includes one or more images of the rear side of the first vehicle 210. The vehicle controller 110 uses the sensor information 220 to determine an outline or boundary 225 of the first vehicle 210. The vehicle controller 110 also uses the sensor information to detect one or more taillights (also known as rear lights) 230 of the first vehicle 210. Based on the taillights 230, the vehicle controller 110 determines a taillight distance 235 between the two taillights 230. In some embodiments, the vehicle controller 110 recognizes the first vehicle 210 based on the outline 225 and/or the taillights 230 and looks up the taillight distance 235 in a database.

The vehicle controller 110 also determines a following distance 240 between the first vehicle 210 and the following vehicle 205. The vehicle controller 110 may extrapolate the following distance 240 based on the taillight distance 235.

The vehicle controller 110 can also detect lane markings 245 for the lane 215 from the sensor information 220. Using the taillight distance 235, the vehicle controller 110 determines a lane width 250 for the current lane 215. Based on the lane markings 245 and the outline 225, the vehicle controller 110 can determine where in the lane 215 the first vehicle 210 is and how far the first vehicle 210 is from the edges of the lane 215.

For the purposes of this discussion, the first vehicle 210 can include, but are not limited to, sedans, sportscars, vans, panel vans, pick-up trucks, buses, trolley cars, public transportation, tractor trailers, 18-wheelers, RVs (recreational vehicle), motorcycles, scooters, bicycles, trailers, emergency vehicles, farm vehicles, oversized vehicles, and/or any other type of vehicle 100. In some embodiments, the vehicle controller 110 is capable of recognizing the first vehicle 210 using the outline 225 and the taillights 230 based on category, such as tractor trailer or emergency vehicle, or on type, such as an individual make and/or model for the first vehicle 210.

FIG. 3 illustrates a schematic diagram of an exemplary system 300 for following a vehicle, in accordance with at least one embodiment. In the exemplary embodiment, system 300 is in a vehicle, such as vehicle 100 (shown in FIG. 1) or following vehicle 205 (shown in FIG. 2). System 300 controls the operation of the vehicle 100.

In the exemplary embodiment, the system 300 includes one or more cameras 305 in communication with a following processor 310 (also known as a following controller 310). The one or more cameras 305 are sensors 105 (shown in FIG. 1) for detecting the surroundings of the vehicle 100. In the exemplary embodiment, the one or more cameras 305 are forward facing and allow the system 300 to determine what is in front of the vehicle 100. In some embodiments, the following processor 310 is a part of the vehicle controller 110 (shown in FIG. 1). In the exemplary embodiment, the following processor 310 is separate from and in communication with the vehicle controller 110.

In the exemplary embodiment, the following processor 310 communicates with other components of the system 300 via a controller area network (CAN) bus, some other embodiments may also include an A-Ethernet or other network, for example. The CAN bus 320 is a rugged digital serial bus used in vehicle environments. The CAN bus 320 allows the following processor 310 to communicate with the other components of the vehicle 100.

In the exemplary embodiment, the following processor 310 receives sensor information 220 (shown in FIG. 2) from the one or more cameras 305. The following processor 310 then detects the outline 225 and the taillights 230 of the first vehicle 210 (all shown in FIG. 2). The following processor 310 uses the taillights 230 to determine the taillight distance 235 and then the following distance 240 (both shown in FIG. 2) for the first vehicle 210. Based on the distances 235 and 240 and the position of the first vehicle 210 in the lane 215, the following processor 310 determines a path for the following vehicle 205. Then the following processor 310 calculates one or more steering adjustments and transmits those steering adjustments to a steering actuator 325 of the following vehicle 205. This allows the following vehicle 205 to adjust its course of direction to continue following the first vehicle 210. While the above embodiment describes steering, one having skill in the art would understand that other operations could be performed as well, such as, but not limited to, breaking, accelerating, gear change, and/or any other adjustment to the operation of the following vehicle 205 to ensure that it safely follows the first vehicle 210.

In some embodiments, the following processor 310 is in communication with adaptive cruise control (ACC) 330 and/or LKAS 335 through the CAN bus 320. The following processor 310 can provide the calculated following distance 240 to the ACC 330 for confirmation. The ACC 330 separately determines the following distance 240 based on information from one or more radar sensors 105. In some embodiments, the following processor 310 requests the current following distance 240 from the ACC 330. In other embodiments, the following processor 310 provides its calculated following distance 240 to the ACC 330 and the ACC 330 provides confirmation and/or adjustments.

In further embodiments, the following processor 310 receives information about the lane markings 245 from the LKAS 335. This information can include, but is not limited to, where the lane markings 245 are in relation to the first vehicle 210, where the lane markings 245 are in relation to the following vehicle 205, and the lane width 250 for the currently lane 215 (both shown in FIG. 2).

In other embodiments, the following processor 310 receives information other information, such as GPS and map information 340. In these embodiments, the following processor 310 knows the route that the following vehicle 205 or the first vehicle 210 is planning to take and can plan for lane changes, turns, changes in speed, and other actions during the route.

In further embodiments, the following processor 310 may be in communication with first vehicle 210, such as through a vehicle-to-vehicle (V2V) wireless communication. The first vehicle 210 can transmit information, such as lane change plans, turns, route directions, braking, current speed, and other information to assist the following processor 310 in determining how to safely follow the first vehicle 210.

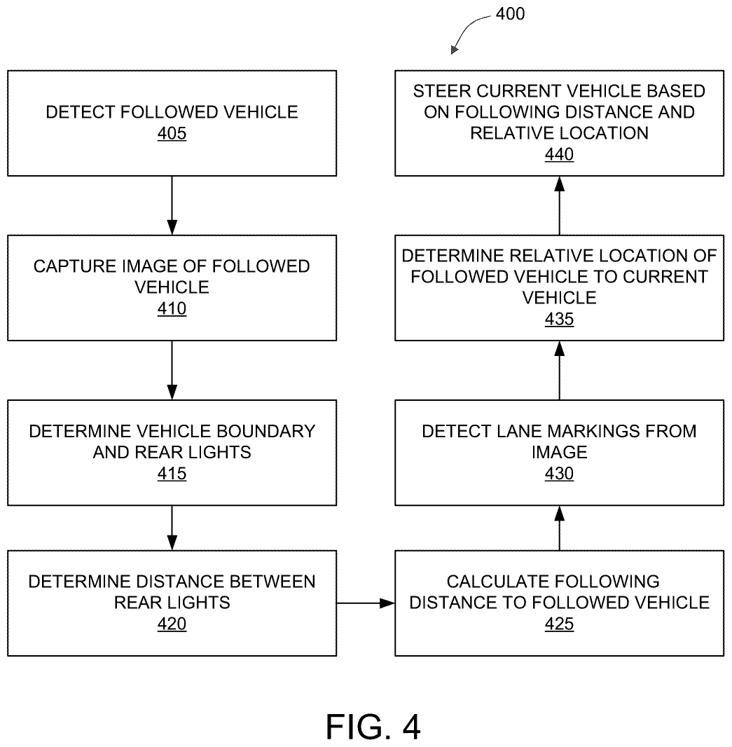

FIG. 4 illustrates a flowchart of a process 400 for following a vehicle 210 (shown in FIG. 2) using the system 300 (shown in FIG. 3), in accordance with at least one embodiment. In the exemplary embodiment, the steps of process 400 are performed by the following controller 310 (shown in FIG. 3) of the following vehicle 205 (shown in FIG. 2). In other embodiments, the steps of process 400 are performed by the vehicle controller 110 of the following vehicle 205.

In the exemplary embodiment, the following controller 310 detects 405 a followed vehicle, such as first vehicle 210 (shown in FIG. 2). The following controller 310 detects 405 the first vehicle based on sensor information 220 from one or more cameras 305 (shown in FIG. 3). In some embodiments, the following controller 310 is already set to follow the first vehicle 210. In other embodiments, the following controller 310 just detects 405 the first vehicle 210 for the first time.

In the exemplary embodiment, the following controller 310 captures 410 one or more images of the followed vehicle. The one or more images may be captured 410 by the one or more cameras 305 and then transmitted to the following controller 310. The one or more images are of the rear of the first vehicle 210 that is in front of the following vehicle 205. Based on the one or more images the following controller 310 determines 415 a vehicle boundary 225 (shown in FIG. 2) and the rear lights or taillights 230 of the first vehicle 210. In at least one embodiment, the following controller 310 uses the images to detect the outline 225 of the first vehicle 210 and detects the taillights 230 based on the color and/or differences from the rest of the rear of the first vehicle 210. In some embodiments, the following controller 310 has access to a database of different vehicle outlines 225 with and without taillights 230. The following controller 310 can use the database and the images to recognize the first vehicle 210 and to look-up information about the first vehicle 210. This information can include, but is not limited to, the taillight distance 235, vehicle width, communication protocols, taillight locations, and/or other information about the recognized first vehicle 210.

The following controller 310 determines 420 the distance between the rear lights 230, also known as the taillight distance 235. In some embodiments, the following controller 310 determines 420 the taillight distance 235 based on the one or more images and the observed distance between the taillights 230. In other embodiments, the following controller 310 determines 420 the taillight distance 235 by looking up the information for the first vehicle 210. For example, the first vehicle 210 may be a semi-truck with a trailer. The following controller 310 may recognize the first vehicle as a trailer based on the one or more images. Then the following controller 310 looks up the standardized taillight distance 235 for trailers. In some further embodiments, the following controller 310 also determines the width of the first vehicle 210 based on the outline 225.

The following controller 310 calculates 425 the following distance 240 (shown in FIG. 2), which is the distance between the first vehicle 210 and the following vehicle 205. In the exemplary embodiment, the following controller 310 calculates 425 the following distance 240 based on the taillight distance 235 and how far away the first vehicle 210 appears in the one or more images. In some embodiments, the following controller 310 confirms the following distance 240 with the ACC 330 (shown in FIG. 3). In still further embodiments, the following controller 310 receives the following distance 240 from the ACC 330. In some embodiments, the following controller 310 also uses the width of the first vehicle in calculating the following distance 240.

The following controller 310 detects 430 the lane markings 245 (shown in FIG. 2) based on the one or more images. In some further embodiments, the following controller 310 confirms the lane markings 245 with the LKAS 335 (shown in FIG. 3). In still further embodiments, the following controller 310 receives the locations of the lane markings 245 from the LKAS 335.

In the exemplary embodiment, the following controller 310 determines 435 the relative location of the first vehicle 210 to the following vehicle 205. The following controller 310 determines a path for the following vehicle 205 to get to the current location of the first vehicle 210 safely based on the following distance 240 and the relative locations of the two vehicles 205 and 210. Then the following controller 310 steers 440 the following vehicle 205 along the determined path. In the exemplary embodiment, the following controller 310 transmits instructions to the steering actuator 325 (shown in FIG. 3) to steer 440 the following vehicle 205.

In some further embodiments, the following controller 310 may determine that the first vehicle 210 is changing lanes 215. In these embodiments, the following controller 310 determines which lane 215 that the first vehicle 210 is travelling into. Then the following controller 310 determines if it is safe for the following vehicle 205 to change lanes as well. In some embodiments, the following controller 310 analyzes the data from one or more lateral sensors 105 (shown in FIG. 1) to determine if any vehicles are in the desired lane 215 and how far away those vehicles are. If the following controller 310 determines that it is safe to do so. The following controller 310 instructs the steering actuator 325 to steer the following vehicle 205 into the desired lane 215. If it is not safe to go into the desired lane 215, the following controller 310 stops following the first vehicle 210.

In additional embodiments, the following controller 310 may determine that the first vehicle 210 is making a turn. In these embodiments, the following controller 310 monitors the turn of the first vehicle 210 and guides the following vehicle 205 through the same turn if it is determined safe to do so. The following controller 310 may disengage from following the first vehicle 210 if the following vehicle 205 is unable to make the turn safely.

In some additional embodiments, the following controller 310 receives map and GPS information. In these embodiments, the following controller 310 knows the route that the following vehicle 205 or the first vehicle 210 is planning to take and can plan for lane changes, turns, changes in speed, and other actions during the route.

In further embodiments, the following controller 310 of the following vehicle 205 may be in communication with first vehicle 210, such as through a vehicle-to-vehicle (V2V) wireless communication. The first vehicle 210 can transmit information, such as lane change plans, turns, route directions, braking, current speed, and other information to assist the following controller 310 in determining how to safely follow the first vehicle 210.

In some embodiments, the following controller 310 has access to one or more user preferences. Examples of user preferences include, but are not limited to, maximum speed, maximum speed above speed limit, minimum following distance 240, following distances 240 based on vehicle speed, preferred turning radius, preferred amount of space for lane change, when to stop following a first vehicle 210, and/or other user preferences for following purposes. In these embodiments, the following controller 310 determines the desired following distance 240, vehicle speed, and other attributes of the following vehicle 205 based on the user preferences.

In other embodiments, the following controller 310 learns the taillight distances 235 for different vehicle outlines 225 overtime using one or more types of machine learning. For example, the following vehicle 205 may travel in a city with public transportation buses. The following vehicle 205 may then capture 410 images of the rear of the buses and determine the following distance 240 and taillight distance 235 for the bus. The following vehicle 205 can confirm its calculated following distance 240 by communicating with the ACC 330. If the following distance 240 is incorrect, then so is the taillight distance 235 and the following controller 310 can update the stored taillight distance 235 for the buses.

In some embodiments, the following controller 310 also adds additional information to the calculation and/or paths based on the current weather conditions. In these embodiments, the following controller 310 may update the attributes of the following vehicle 205 to allow for safe travel during adverse weather conditions, such as, but not limited to, rain, snow, low visibility, and/or other conditions.

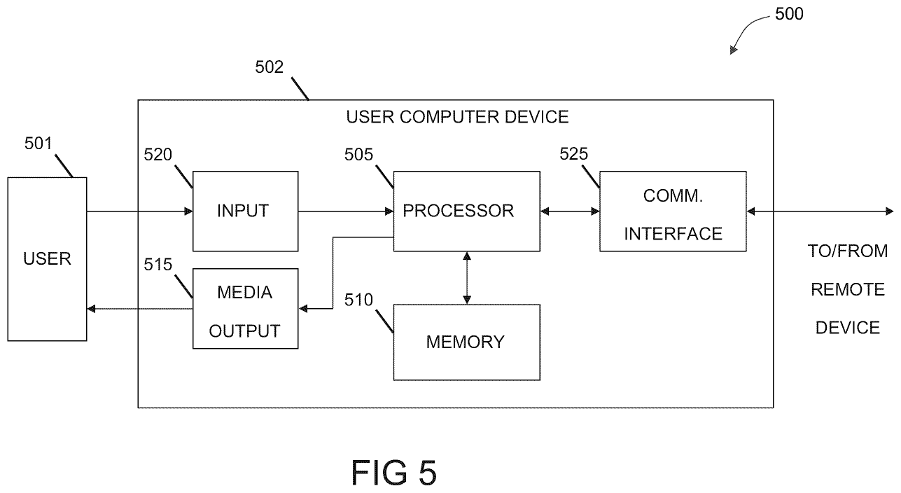

FIG. 5 depicts an exemplary configuration of the computer devices shown in FIG. 3, in accordance with one embodiment of the present disclosure. User computer device 502 may be operated by a user 501. In the exemplary embodiment, user 501 may be similar to driver 115 (shown in FIG. 1). User computer device 502 may include, but is not limited to, vehicle controller 110, mobile device 125 (both shown in FIG. 1), following processor 310, ACC 330, and LKAS 335 (all shown in FIG. 3). User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501, such as through the infotainment panel 130 (shown in FIG. 1). A graphical user interface may include, for example, route information. In some embodiments, user computer device 502 may include an input device 520 for receiving input from user 501. User 501 may use input device 520 to, without limitation, entering or updating one or more user preferences.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as mobile device 125 or vehicle controller 110. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from vehicle controller 110. A client application allows user 501 to interact with, for example, vehicle controller 110. For example, instructions may be stored by a cloud service, and the output of the execution of the instructions sent to the media output component 515.

Processor 505 executes computer-executable instructions for implementing aspects of the disclosure. In some embodiments, the processor 505 is transformed into a special purpose microprocessor by executing computer-executable instructions or by otherwise being programmed. For example, the processor 505 may be programmed with the instructions such as illustrated in FIG. 4.

In some embodiments, user computer device 502 may include, or be in communication with, one or more sensors, such as sensor 105 (shown in FIG. 1) or camera 305 (shown in FIG. 3). User computer device 502 may be configured to receive data from the one or more sensors and store the received data in memory area 510. Furthermore, user computer device 502 may be configured to transmit the sensor data to a remote computer device, such as vehicle controller 110 or mobile device 125, through communication interface 525.

The types of autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality.

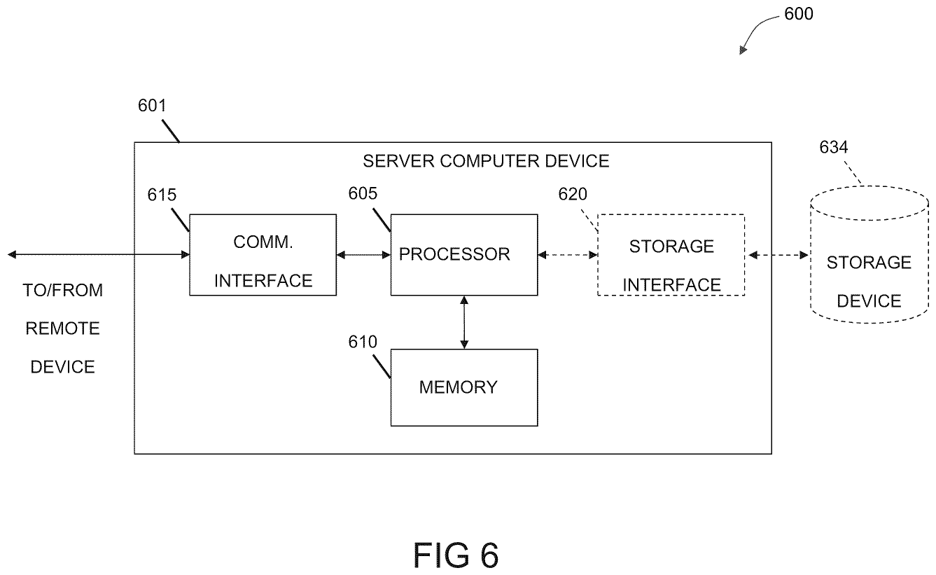

FIG. 6 illustrates an example configuration of the server system shown in FIG. 3, in accordance with one embodiment of the present disclosure. Server computer device 601 may include, but is not limited to, vehicle controller 110 (shown in FIG. 1), following processor 310, ACC 330, and LKAS 335 (all shown in FIG. 3). Server computer device 601 also includes a processor 605 for executing instructions. Instructions may be stored in a memory area 610. Processor 605 may include one or more processing units (e.g., in a multi-core configuration).

Processor 605 is operatively coupled to a communication interface 615 such that server computer device 601 is capable of communicating with a remote device such as another server computer device 601, vehicle controller 110, following controller 310, ACC 330, or LKAS 335. For example, communication interface 615 may receive requests from the vehicle controller 110 in the first vehicle 210 (shown in FIG. 2) from via the Internet.

Processor 605 may also be operatively coupled to a storage device 634. Storage device 634 is any computer-operated hardware suitable for storing and/or retrieving data, such as, but not limited to, data associated with a database. In some embodiments, storage device 634 is integrated in server computer device 601. For example, server computer device 601 may include one or more hard disk drives as storage device 634. In other embodiments, storage device 634 is external to server computer device 601 and may be accessed by a plurality of server computer devices 601. For example, storage device 634 may include a storage area network (SAN), a network attached storage (NAS) system, and/or multiple storage units such as hard disks and/or solid state disks in a redundant array of inexpensive disks (RAID) configuration.

In some embodiments, processor 605 is operatively coupled to storage device 634 via a storage interface 620. Storage interface 620 is any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 executes computer-executable instructions for implementing aspects of the disclosure. In some embodiments, the processor 605 is transformed into a special purpose microprocessor by executing computer-executable instructions or by otherwise being programmed. For example, the processor 605 is programmed with instructions such as illustrated in FIGS. 3 and 5.

For the methods discussed directly above, the wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; hazard avoidance, navigation or GPS-related systems; security and/or anti-hacking measures; and/or theft prevention systems.

In the exemplary embodiment, a vehicle 100, such as the following vehicle 205, includes a plurality of sensors 105 including a first sensor 105. In some embodiments, the first sensor is a front facing camera 305. The vehicle 100 also includes a vehicle controller 110, such as the following processor 310. The vehicle controller 110 collects a plurality of sensor information 220 observed by at least the first sensor 105 during operation of the vehicle 100. The plurality of sensor information 220 includes one or more images of the first vehicle 210 captured by the front facing camera 305.

The vehicle controller 110 detects a first vehicle 210 ahead of the vehicle 100 in a direction of travel of the vehicle 100 based on the plurality of sensor information 220. In some embodiments, the vehicle controller 110 determines an outline 225 of the first vehicle 210 based on the plurality of sensor information 220. The vehicle controller 110 detects two or more taillights 230 of the first vehicle 210 based on the plurality of sensor information 220 The vehicle controller 110 determines a distance 235 between the two or more taillights 230. The vehicle controller 110 calculates a following distance 240 between the first vehicle 210 and the vehicle 100 based on the distance 235 between the two or more taillights 235 and the plurality of sensor information 220.

The vehicle controller 110 detects a plurality of lane markings 245 based on the plurality of sensor information 220. The vehicle controller 110 adjusts steering of the vehicle 100 to follow the first vehicle 210 based on the plurality of lane markings 245 and the following distance 240. In some embodiments, the vehicle controller 110 transmits one or more instructions to a steering actuator 325 of the vehicle 100 to adjust the steering of the vehicle 100.

In some embodiments, the vehicle controller 110 look-ups at least one of a category and a type for the first vehicle 100 based on the outline 225. The vehicle controller 110 retrieves the distance 235 between the two or more taillights 230 based on the look-up.

In some embodiments, the vehicle controller 110 confirms the following distance 240 with an adaptive cruise controller (ACC). In some further embodiments, the vehicle controller 110 confirms the plurality of lane markings 245 with a lane keeping assistance system (LKAS). In still further embodiments, the vehicle controller 110 retrieves map and/or Global Positioning System (GPS) information. In yet further embodiments, the vehicle controller 110 receives travel information from the first vehicle 210 via a wireless connection.

In some embodiments, the vehicle controller 110 engages in a vehicle following mode. In this mode, the vehicle controller 110 is controlling the vehicle 100 to follow the first vehicle 210.

In further embodiments, the vehicle controller 110 determines that the first vehicle 210 is changing lanes 215 based on the plurality of lane markings 245 and the plurality of sensor information 220. The vehicle controller 110 determines whether or not it is safe for the vehicle 100 to change lanes 215. If the determination is that it is safe for the vehicle 100 to change lanes 215, the vehicle controller 110 controls the vehicle 100 to follow the first vehicle 210 in changing lanes 215. If the determination is that it is not safe for the vehicle 100 to change lanes 215, the vehicle controller 110 disengages from following the first vehicle 100.

In additional embodiments, the vehicle controller 110 determines that the first vehicle 210 is making a turn based on the plurality of lane markings 245 and the plurality of sensor information 220. The vehicle controller 110 determines whether or not it is safe for the vehicle 100 to make the turn. If the determination is that it is safe for the vehicle 100 to make the turn, the vehicle controller 110 follows the first vehicle 210 in making the turn.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on vehicles, stations, nodes, or mobile devices, or associated with smart infrastructures and/or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, fewer, or alternative elements and respective functionalities, including those discussed elsewhere herein, which themselves may include or be implemented according to computer-executable instructions stored on non-transitory computer-readable media or medium.

In the exemplary embodiment, a processing element may be instructed to execute one or more of the processes and subprocesses described above by providing the processing element with computer-executable instructions to perform such steps/sub-steps, and store collected data (e.g., vehicle outlines and information, etc.) in a memory or storage associated therewith. This stored information may be used by the respective processing elements to make the determinations necessary to perform other relevant processing steps, as described above.

The aspects described herein may be implemented as part of one or more computer components, such as a client device, system, and/or components thereof, for example. Furthermore, one or more of the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics and information, traffic timing, previous trips, and/or actual timing. The machine learning programs may utilize deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to determine user preferences and recognize vehicle outlines.

Based upon these analyses, the processing element may learn how to identify characteristics and patterns that may then be applied to analyzing image data, model data, and/or other data. For example, the processing element may learn, to identify trends of traffic based on vehicle types and outlines. The processing element may also learn how to identify trends that may not be readily apparent based upon collected vehicle information.

The exemplary systems and methods described and illustrated herein therefore significantly increase the safety of operation of autonomous and semi-autonomous vehicles by reducing the potential for damage to the vehicles and the vehicle's surroundings.

The present systems and methods are further advantageous over conventional techniques the embodiments herein are not confined to a single type of vehicle and/or situation but may instead allow for versatile operation within multiple different types of vehicles, including ground craft, watercraft, aircraft, and spacecraft. Accordingly, these novel techniques are of particular value to vehicle manufacturers who desire to have these methods and systems available for the users of their vehicles.

Exemplary embodiments of systems and methods for securely navigating traffic lights are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A vehicle comprising:
a plurality of sensors including a first sensor; and
a vehicle controller, wherein the vehicle controller is programmed to:
collect a plurality of sensor information observed by at least the first sensor during operation of the vehicle;
detect a first vehicle ahead of the vehicle in a direction of travel of the vehicle based on the plurality of sensor information;
detect two or more taillights of the first vehicle based on the plurality of sensor information;
determine a distance between the two or more taillights;
calculate a following distance between the first vehicle and the vehicle based on the distance between the two or more taillights and the plurality of sensor information;
detect a plurality of lane markings based on the plurality of sensor information; and
adjust steering of the vehicle to follow the first vehicle based on the plurality of lane markings and the following distance.

2. The vehicle of claim 1, wherein the first sensor is a front facing camera, and wherein the plurality of sensor information includes one or more images of the first vehicle captured by the front facing camera.

3. The vehicle of claim 1, wherein the vehicle controller is further programmed to determine an outline of the first vehicle based on the plurality of sensor information.

4. The vehicle of claim 3, wherein the vehicle controller is further programmed to look-up at least one of a category and a type for the first vehicle based on the outline.

5. The vehicle of claim 4, wherein the vehicle controller is further programmed to retrieve the distance between the two or more taillights based on the look-up.

6. The vehicle of claim 1, wherein the vehicle controller is further programmed to confirm the following distance with an adaptive cruise controller (ACC).

7. The vehicle of claim 1, wherein the vehicle controller is further programmed to confirm the plurality of lane markings with a lane keeping assistance system (LKAS).

8. The vehicle of claim 1, wherein the vehicle controller is further programmed to retrieve map and/or Global Positioning System (GPS) information.

9. The vehicle of claim 1, wherein the vehicle controller is further programmed to receive travel information from the first vehicle via a wireless connection.

10. The vehicle of claim 1, wherein the vehicle controller is further programmed to engage in a vehicle following mode, wherein the vehicle controller is controlling the vehicle to follow the first vehicle.

11. The vehicle of claim 1, wherein the vehicle controller is further programmed to:
determine that the first vehicle is changing lanes based on the plurality of lane markings and the plurality of sensor information;
determine whether or not it is safe for the vehicle to change lanes; and
if the determination is that it is safe for the vehicle to change lanes, follow the first vehicle in changing lanes.

12. The vehicle of claim 11, wherein the vehicle controller is further programmed to if the determination is that it is not safe for the vehicle to change lanes, disengage from following the first vehicle.

13. The vehicle of claim 1, wherein the vehicle controller is further programmed to:
determine that the first vehicle is making a turn based on the plurality of lane markings and the plurality of sensor information;
determine whether or not it is safe for the vehicle to make the turn; and
if the determination is that it is safe for the vehicle to make the turn, follow the first vehicle in making the turn.

14. The vehicle of claim 1, wherein the vehicle controller is further programmed to transmit one or more instructions to a steering actuator of the vehicle to adjust the steering of the vehicle.

15. A computer device comprising:
at least one memory; and
at least one processor in communication with the at least one memory, the at least one processor programmed to:
collect a plurality of sensor information observed by at least a first sensor during operation of a vehicle;
detect a first vehicle ahead of the vehicle in a direction of travel of the vehicle based on the plurality of sensor information;
detect two or more taillights of the first vehicle based on the plurality of sensor information;
determine a distance between the two or more taillights;
calculate a following distance between the first vehicle and the vehicle based on the distance between the two or more taillights and the plurality of sensor information;
detect a plurality of lane markings based on the plurality of sensor information; and
adjust steering of the vehicle to follow the first vehicle based on the plurality of lane markings and the following distance.

16. The computer device of claim 15, wherein the computer device is associated with the first sensor, wherein the first sensor comprises one or more front facing cameras, and wherein the plurality of sensor information includes one or more images of the first vehicle captured by the one or more front facing cameras.

17. The computer device of claim 15, wherein the computer device is further programmed to determine an outline of the first vehicle based on the plurality of sensor information.

18. The computer device of claim 17, wherein the computer device is further programmed to:
look-up at least one of a category and a type for the first vehicle based on the outline; and
retrieve the distance between the two or more taillights based on the look-up.

19. The vehicle of claim 15, wherein the computer device is further programmed to:
confirm the following distance with an adaptive cruise controller (ACC); and
confirm the plurality of lane markings with a lane keeping assistance system (LKAS).

20. A method for controlling a vehicle, the method implemented by a vehicle controller associated with the vehicle comprising at least one processor in communication with at least one memory, the method comprising:
collecting a plurality of sensor information observed by at least a first sensor during operation of the vehicle;
detecting a first vehicle ahead of the vehicle in a direction of travel of the vehicle based on the plurality of sensor information;
detecting two or more taillights of the first vehicle based on the plurality of sensor information;
determining a distance between the two or more taillights;
calculating a following distance between the first vehicle and the vehicle based on the distance between the two or more taillights and the plurality of sensor information;
detecting a plurality of lane markings based on the plurality of sensor information; and
adjusting steering of the vehicle to follow the first vehicle based on the plurality of lane markings and the following distance.
